(19) United States
(12) Patent Application Publication
(10) Pub. No.: US 2010/0313765 A1
(43) Pub. Date: Dec. 16, 2010

(54) WATER HEATING SYSTEM FOR HOT BEVERAGE DISPENSING MACHINE

(76) Inventor: Robert Hale, Toronto (CA)

Correspondence Address: PERRY + CURRIER INC., 1300 YONGE STREET, SUITE 500, TORONTO, ON, M4T-1X3, CA

(21) Appl. No.: 12/483,348

(22) Filed: Jun. 12, 2009

(51) Int. Cl. A47J 31/44; B67D 5/62; B65D 25/40; B67D 5/08; F24H 1/10

(52) U.S. Cl. 99/288; 222/146.2; 222/566; 222/54; 392/466

(57) ABSTRACT

A water heating system for use in a hot beverage dispensing machine. The water heating system comprises a water reservoir enabled to store a volume of water suitable for use in the hot beverage dispenser, a water pump enabled to receive water from the water reservoir and pump the water through the system, and a water heater enabled to receive water from the water pump, the water heater being configured to heat water passing therethrough. The water heating system also provides a water directing device enabled to receive water from the water heater, the water directing device being capable of selecting between a recirculation mode, and a dispensing mode. During the recirculation mode, the water heater is activated, and the water directing device directs water back to the water reservoir, so as to heat and maintain the water in the water reservoir at a predetermined set temperature intermediate that of room temperature and a predetermined brew temperature. During the dispensing mode, the water heater is activated, and the water directing device delivers the water to a demand point, the water heater serving to boost the temperature of the water to the predetermined brew temperature.

### FIELD

The present invention pertains to the field of hot beverage dispensers, and in particular to a water heating system for use in a hot beverage dispensing machine.

### BACKGROUND

Single serve hot beverage dispensing machines are very popular for providing a fresh tasting beverage in a short period of time without having to produce multiple servings. Single serve beverages are produced in beverage dispensing machines using disposable beverage cartridges containing products such as coffee grinds, tea leaves or other soluble products.

When operating a hot beverage dispensing machine, the beverage making process generally comprises the injection of hot water under pressure into the beverage cartridge, through the beverage product, and out of the cartridge into a cup or mug. The use of a single serve hot beverage dispensing machine is very convenient, hence their placement in a wide range of residential and commercial settings.

With the growing focus upon environmentally conscience products and practices, it was determined that single serve hot beverage dispensing machines were quite wasteful of energy. Hot beverage dispensing machines typically employ a water reservoir that is heated to a desired temperature used for beverage extraction (brewing), which is generally in the range of 195° C. to 205° C. During periods of low usage, particularly in commercial settings where the machines are less likely to be turned off, the costs associated with the heating and maintaining of this heated water can be high, due to excessive energy consumption.

In addition, it was determined that spent beverage cartridges were not being routinely disposed of through recycling, but were rather being placed into standard municipal garbage. Spent cartridges have a tendency to drip, but more importantly, the remaining moisture in the cartridges has the potential to create mold and develop unpleasant odors. To avoid these issues, spent cartridges are not routinely recycled, so as to avoid their accumulation.

It is therefore desirable to present a more environmentally conscience system and method of heating water for use in hot beverage dispensing machines.

### SUMMARY

According to a first aspect, provided is a water heating system for use in a hot beverage dispenser, comprising:

a water reservoir enabled to store a volume of water suitable for use in said hot beverage dispenser;

a water pump enabled to receive water from said water reservoir and pump said water through said system;

a water heater enabled to receive water from said water pump, said water heater being configured to heat water passing therethrough;

a water directing device enabled to receive water from said water heater, said water directing device being capable of selecting between a recirculation mode, and a dispensing mode;

wherein during said recirculation mode, said system directs water contained within said water reservoir to recirculate through a loop comprising said water heater, so as to maintain said water in said water reservoir at a predetermined set temperature intermediate that of room temperature and a predetermined brew temperature; and

wherein during said dispending mode, said system directs water through said water heater prior to delivery to a demand point, said water heater serving to boost the temperature of said water to said predetermined brew temperature.

According to another aspect, provided is a method of heating water for a hot beverage dispensing apparatus, said method comprising:

heating a first volume of water to a predetermined temperature intermediate that of room temperature and a predetermined brew temperature and maintaining said first volume of water at said predetermined temperature;

heating a second volume of water removed from said first volume of water to a predetermined brew temperature; and

delivering said second volume of water to a demand point for brewing a hot beverage.

According to an alternate aspect, in a water heating system for use in a hot beverage dispenser, provided is a method of heating water comprising:

preheating a reservoir of water to a predetermined temperature intermediate that of room temperature and a predetermined brew temperature;

boosting a select volume of water from said reservoir of water to a predetermined brew temperature immediately prior to delivery to a demand point;

wherein said preheating and said boosting are each performed by a single water heater provided in said water heating system.

Additional aspects and advantages will be apparent to a person of ordinary skill in the art, residing in the details of construction and operation as more fully hereinafter described and claimed, reference being had to the accompanying drawings.

### FIGURES

Embodiments of the present application will now be described, by way of example only, with reference to the attached Figures, wherein

FIG. 1 is a schematic representation of a first embodiment of the water heating system;

FIG. 2 is a schematic representation of a second embodiment of the water heating system;

FIG. 2a is a schematic representation of a third embodiment of the water heating system;

FIG. 3 is a process diagram of a first operational configuration of the water heating system; and

FIG. 4 is a process diagram of a second operation configuration of the water heating system, including heat recapture.

### DESCRIPTION

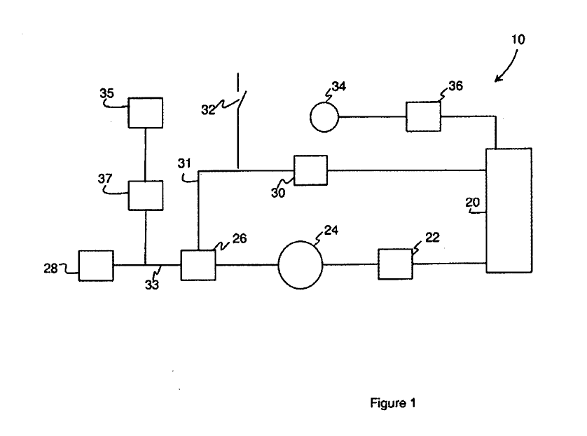

Depicted in FIG. 1 is a heating system 10 for use in a hot beverage dispensing apparatus. The heating system generally comprises a water reservoir 20, a water pump 22, and a water heater 24. Each of water reservoir 20, water pump 22, and water heater 24 are interconnected so as to permit the pressurized flow of water in the direction of water reservoir 20, water pump 22 and water heater 24. The flow of water from water reservoir 20 through the heating system is facilitated by water pump 22.

As shown, water heater 24 is connected to a water directing device 26. Water directing device 26 permits the selection of directional flow of water to either a demand point (e.g. hot beverage dispensing mechanism) 28 or back to water reservoir 20. As such, according to the selected directional flow as determined by water directing device 26, heating system 10 provides for at least two modes of operation. In a first mode, herein referred to as the dispensing mode, water is directed from water reservoir 20, to demand point 28, through water pump 22, water heater 24, water directing device 26 and conduit 33. In a second mode, herein referred to as the recirculation mode, water is directed from water reservoir 20, back to water reservoir 20, through water pump 22, water heater 24, water directing device 26 and conduit 31. Water directing device 26 can be any suitable device capable of selectively directing the flow of water to at least one of a plurality of flow paths. In one non-limiting example, water directing device 26 is a three-way solenoid valve.

Water reservoir 20 is enabled to contain a volume of water used in the beverage brewing process. In one embodiment, water reservoir 20 has a volume (e.g. 1-2 litres) suitable for brewing a plurality of beverages.

The brew temperature of water used in a hot beverage preparation process is typically in the range of 195° F. to 205° F. In heating system 10, water that is contained within water reservoir 20 is maintained at a temperature that is generally intermediate to the brew temperature, and room temperature. For example, heating system 10 is configured to maintain the water in water reservoir 20 at a temperature of approximately 130° F. To achieve this, the heating system is operated in recirculation mode, whereby the water contained within water reservoir 20 is recirculated through water pump 22, water heater 24, water directing device 26, back to water reservoir 20 through conduit 31. During recirculation, water heater 24 is activated (e.g. turned on) to heat water passing there-through, such that the water in water reservoir 20 increases in temperature until a predetermined set temperature is reached (e.g. 130° C.).

When the water is needed for beverage preparation, heating system 10 is operated in dispensing mode, whereby the water contained within water reservoir 20 is directed through water pump 22, water heater 24, water directing device 26 to demand point 28, through conduit 33. During dispensing mode, water heater 24 is activated (turned on) to heat the water to the desired brew temperature (e.g. 195° F. to 205° F.), the water being subsequently used in the beverage preparation process at demand point 28.

As such, water heater 24 provides for two functions. First, during the recirculation mode, water heater 24 is activated and used to establish and maintain the water temperature in water reservoir 20 at a preselected intermediate temperature (e.g. 130° F.). Second, during the dispensing mode, water heater 24 is activated and used to increase the temperature of a select volume of water to a desired brew temperature (e.g. 195° F. to 205° F.), suitable for use at demand point 28.

In some embodiments, heating system 10 may further comprise additional components such as connectors, check valves, pressure release valves, etc. as generally known in the art of heated beverage machines. For example, in one embodiment, heating system 10 further comprises a check valve 30 situated on conduit 31 connecting water directing device 26 to water reservoir 20, so as to maintain the flow of water in the direction of water reservoir 20, water pump 22, water heater 24, water directing device 26 and back to water reservoir 20.

As will be appreciated, heating system 10 is provided with suitable plumbing (e.g. conduits, connectors, valves, etc.) so as to permit the pressurized flow of water as detailed above. In some embodiments, suitable plumbing is provided by way of copper tubing and compatible fittings permitting the connection of the various components detailed above. In other embodiments, suitable plumbing is provided by way of polymer-based tubing and complementary fittings. As will be appreciated, in other embodiments, other suitable materials, or combination of materials may be implemented.

In one embodiment, heating system 10 further comprises a spigot 32 for dispensing hot water from the system. For example, spigot 32 may be situated on conduit 31, as shown in FIG. 1. Where a spigot 32 is provided, the heating system will generally include check valve 30 situated between spigot 32 and water reservoir 20 so as to prevent the flow of water directly from water reservoir 20.

As will be appreciated, water reservoir 20 can be configured a number of different ways. In one exemplary embodiment, water reservoir 20 is configured for manual filling, wherein water is added to water reservoir 20 through a suitably sized opening. In another exemplary embodiment, water reservoir 20 is configured to be directly connected to a water source 34, whereby a user can manually open/close water source 34 to fill water reservoir 20. In a further exemplary embodiment, where water reservoir 20 is configured to be directly connected to water source 34, heating system 10 is further provided with a valve 36 that permits control over the flow of water from water source 34 into water reservoir 20.

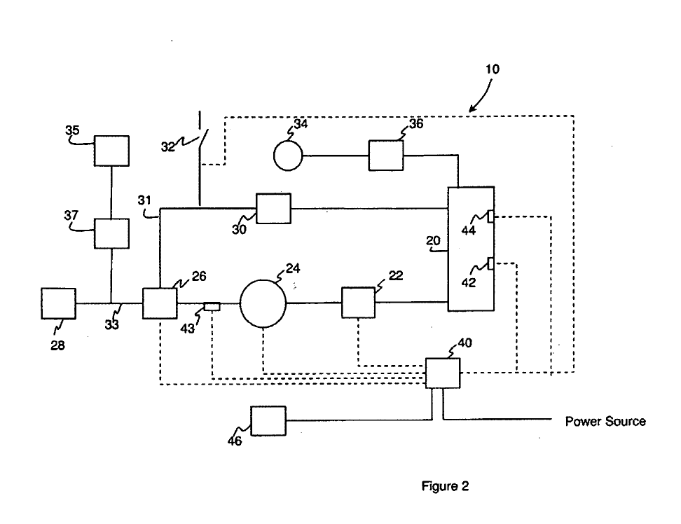

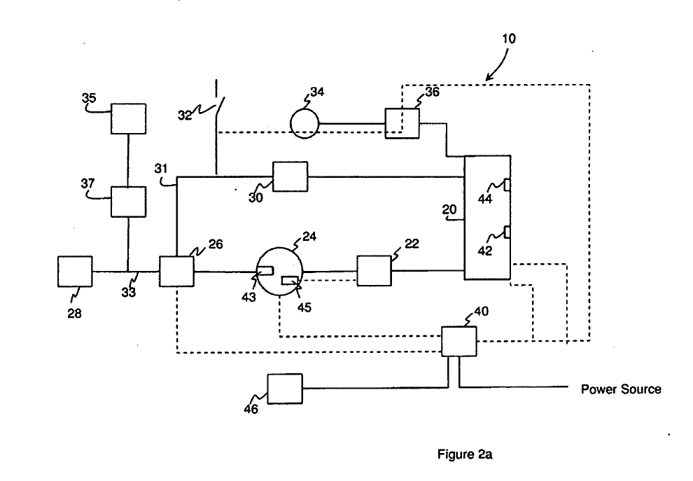

While the various components of heating system 10 can be operated in a fully manual configuration whereby a user directly controls water pump 22, water directing device 26 and other associated components of the system, heating system 10 can also be provided with a central control unit 40, as shown in FIG. 2. Central control unit 40 can be any suitable processing unit (e.g. a microprocessor) capable of receiving, processing and sending signals in respect of the various components of heating system 10.

Continuing with FIG. 2, central control unit 40 can be connected to communicate with one or more of water pump 22, water heater 24 and water directing device 26, so as to permit centralized control of these components. Central control unit 40 can also be connected to communicate with spigot 32 when present. For monitoring heating system 10, additional sensors may be provided, such as a temperature sensor 42 and water level sensor 44 provided in water reservoir 20. When provided with sensors (e.g. temperature sensor 42 and water level sensor 44), these components will be suitably connected to central control unit 40.

Central control unit 40 is provided with a user interface 46 that permits a user to input selections, for example through the use of buttons or a touch screen display. Accordingly, central control unit 40 is enabled to receive selections from a user through user interface 46, and send out control signals to the various components of heating system 10, so as to obtain the desired end product (e.g. a brewed hot beverage). Typical selections available to a user generally include the size of beverage (e.g. small beverage, medium beverage, large beverage). For example, on selecting a medium beverage, central control unit 40 would send suitable command signals to each of water directing device 26, water heater 24, and water pump 22 to direct a medium volume of water from water reservoir 20 through to demand point 28 (e.g. dispensing apparatus).

In some embodiments, the volume of water corresponding to small, medium, and large can be programmed into central control unit 40, with central control unit 40 activating water pump 22 for a sufficient period of time to deliver the selected volume. In other embodiments, heating system 10 may comprise a flow meter which in combination with a timer, allows central control unit 40 to calculate the volume of water dispensed. In still further embodiments, certain components of heating system 10, for example water heater 24 may be configured with built in flow meters. In this way, central control unit 40 obtains information on the volume of water passing through the heating system, and adjusts other components (e.g. water pump 22) accordingly to achieve the desired output. Still further methods and mechanisms for achieving a desired volume of water are possible and are contemplated for use in heating system 10.

In some embodiments, central control unit 40 can be enabled to monitor heating system 10 using sensors provided for example on water reservoir 20 (e.g. temperature sensor 42 and water level sensor 44). With temperature sensor 42, central control unit 40 can initiate a recirculation mode when necessary to maintain the water temperature within water reservoir 20 at the predetermined set temperature (e.g. 130° C.). For example, on detecting a temperature below the predetermined set temperature, central control unit 40 can activate water pump 22 and water heater 24, while directing water directing device 26 to direct water flow in the direction of water reservoir 20 (recirculation mode). On detecting a water temperature that at least equals the predetermined set temperature, central control unit deactivates water pump 22 and water heater 24, and returns to a stand-by mode.

In some embodiments, central control unit 40 can also be enabled to monitor the water level within water reservoir 20 using a suitable sensor (e.g. water level sensor 44). Where a low water level is detected, central control unit 40 can trigger a action to either alert the user to a low water level condition, or activate the necessary components to permit the addition of water to water reservoir 20. For example, on detection of a low water level condition, central control unit 40 can be enabled to disable water pump 22 and water heater 24 so as to prevent damage to heating system 10 where insufficient water is present for proper operation. On disabling heating system 10, central control unit 40 can activate a warning light to alert users of the low water level condition. Alternatively, where heating system 10 is connected to a water source 34, central control unit 40 can be enabled to activate a suitable valve 36 such that water is allowed to flow from water source 34 into water reservoir 20 until a set water level is reached.

In some embodiments, heating system 10 may comprise additional sensors to enable additional monitoring and control over system processes. For example, heating system 10 may comprise an additional temperature sensor 43 after water heater 24. In circumstances where the flow of water through this additional temperature sensor shows a below-optimal temperature (e.g. <195° F.), central control unit 40 can adjust system components accordingly to increase the temperature output of heating system 10. In some embodiments, central control unit 40 may signal for an adjustment of one or both of water beater 24 and water pump 22, so as to achieve a greater transfer of heat. For example, central control unit 40 may signal water pump 22 to slow the flow of water through water heater 24, thereby enabling a greater transfer of heat into the water passing there-through. Alternatively, central control unit 40 may signal water heater 24 to increase in temperature, again enabling a greater transfer of heat into the water passing there-through. While the aforementioned additional temperature sensor 43 may be a separate component added to heating system 10, in some embodiments, the aspect of thermal control to govern the quantity of heat added to the water may be accomplished by specialized components that combine various functionalities.

In some embodiments, heating system 10 may incorporate a water heater having built in a temperature sensor and microprocessor that can be used to effect direct control over other system components, such as water pump 22, without having to direct signals through central control unit 40. For example, in the alternate embodiment of heating system 10 shown in FIG. 2a, water heater 24 is shown with a built in temperature sensor 43 and microprocessor 45 that permits direct control over water pump 22. The microprocessor 45 may also be configured to control the temperature output of water heater 24, so as to achieve the desired water temperature when discharging water to demand point 28.

In embodiments where heating system 10 is provided with spigot 32, the spigot may be provided with a suitable switch that alerts central control unit 40 that a user is requesting hot water, that is without preparation of a beverage in an associated dispensing apparatus at demand point 28. On detection that a user has opened spigot 32 central control unit 40 can activate water pump 22 and heater device 24, while directing water directing device 26 to direct water to conduit 31, which comprises spigot 32. Alternatively, user interface 46 can provide a hot water selection button that instructs central control unit 40 to activate water pump 22, heater device 24, and water directing device 26 as detailed above, as well as opening spigot 32 so as to deliver a specific volume of water at spigot 32.

In some embodiments, regardless of whether heating system 10 is being operated in dispensing mode or recirculation mode, once the operation of either dispensing a beverage, or heating the water in water reservoir 20 is complete, a heat recapture mode is activated. On completion of either dispensing a beverage, or heating the water in water reservoir 20 (or water being dispensed at spigot 32), water heater 24, water directing device 26 and associated conduits (e.g. conduit 31 for recirculation mode, and conduit 33 for dispensing mode) contains residual heated water. To capture this residual heated water, central control unit 40 activates water pump 22, while directing water directing device 26 to direct water through conduit 31, towards water reservoir 20. Unlike the recirculation and dispensing modes, water heater 24 remains deactivated during the heat recapture mode. In this way, the residual heated water is transferred to water reservoir 20. As such, instead of the additional heat introduced into the water during either of the recirculation or dispensing modes being needlessly lost from the deactivated water heater 24, water directing device 26, and associated conduits, the additional heat is directed towards water reservoir 20 for use in maintaining the water contained therein at the predetermined set temperature (e.g. 130° F.).

In some embodiments, heating system 10 further comprises an air pump 35 and check valve 37 situated on conduit 33 between water directing device 26 and demand point 28. Ordinarily, once a selected volume of water has passed through a beverage cartridge, the beverage cartridge is disposed of. Where a volume of water continues to reside within the beverage cartridge, dripping and mold formation often occur. As a result, the beverage cartridges are often disposed of in the regular garbage, so as to avoid any unnecessary mess or odor associated with accumulating spent cartridges. To avoid the mess and odor associated with residual water within spent beverage cartridges, air pump 35 directs a stream of air through to demand point 28, so remove residual water and effectively dry the beverage cartridge just used. By drying the spent beverage cartridge, there is a greater likelihood that consumers would conform to an environmentally conscience regimen of directing spent cartridges to a recycling bin, instead of the regular garbage.

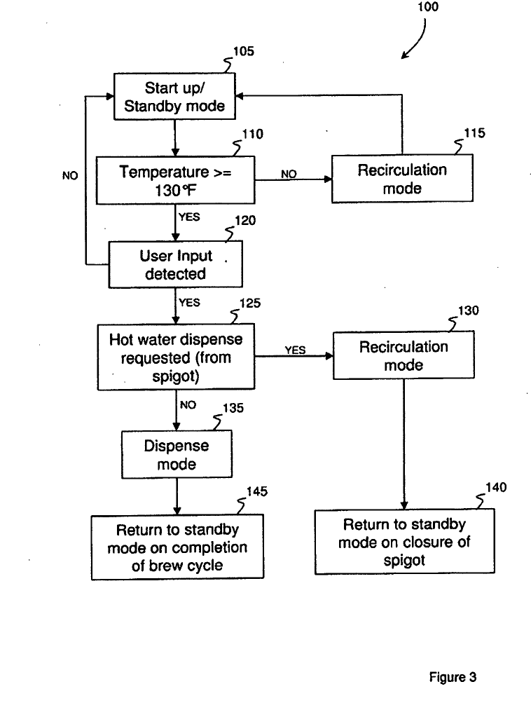

An exemplary operation of heating system 10 will now be discussed with reference to flow diagram 100 provided in FIG. 3. For the purposes of discussion, heating system 10 is configured as shown in FIG. 2.

On startup of heating system 10, the system enters ready-mode (step 105). In ready mode, central control unit 40 is powered up, with water pump 22 and water heater 24 being deactivated.

At step 110, central control unit 40 monitors the temperature of water reservoir 20. When the temperature of water reservoir 20 is less than the predetermined set temperature (e.g. 130° F. ), central control unit 40 switches heating system 10 to recirculation mode (step 115), wherein water pump 22 and water heater 24 are activated, and water directing device 26 is directed to direct water through conduit 31 to water reservoir 20. Recirculation of the water from water reservoir 20 through water pump 22, activated water heater 24, water directing device 26, and conduit 31 back to water reservoir 20 is continued until the temperature of the water in water reservoir 20 reaches the predetermined set temperature.

On verification that the temperature of the water in water reservoir 20 is at least the predetermined set temperature, central control unit 40 monitors for user input (step 120). Where user input is not detected, the system returns to stand-by mode and further monitors the temperature of water contained in water reservoir 20. Where user input is detected, the system determines (step 125) the nature of the user input. If hot water is being requested, central control unit 40 instructs for recirculation mode (step 130), activates water heater 24 and water pump 22, thereby permitting a user to remove heated water at spigot 34 located on conduit 31. If a brewed beverage is being requested, central control unit 40 instructs for dispensing mode (step 135), activates water heater 24 and water pump 22, thereby directing heated water to demand point 28 (e.g. beverage brewing apparatus). On completion of hot water delivery to spigot 34 (step 140), or on completion of brew cycle at demand point 28 (step 145), water heater 24 and water pump 22 are deactivated, and heating system 10 returns to stand-by mode.

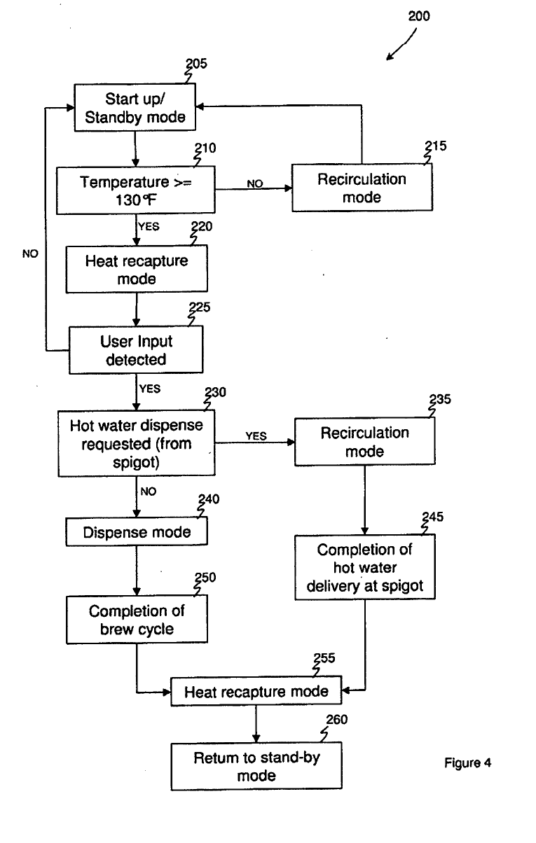

An exemplary operation of heating system 10 with heat recapture will now be discussed with reference to flow diagram 200 provided in FIG. 4. For the purposes of discussion, heating system 10 is configured as shown in FIG. 2.

On startup of heating system 10, the system enters ready-mode (step 205). In ready mode, central control unit 40 is powered up, with water pump 22 and water heater 24 being deactivated.

At step 210, central control unit 40 monitors the temperature of water reservoir 20. When the temperature of water reservoir 20 is less than the predetermined set temperature (e.g. 130° F.), central control unit 40 switches heating system 10 to recirculation mode (step 215), wherein water pump 22 and water heater 24 are activated, and water directing device 26 is directed to direct water through conduit 31 to water reservoir 20. Recirculation of the water from water reservoir 20 through water pump 22, activated water heater 24, water directing device 26, and conduit 31 back to water reservoir 20 is continued until the temperature of the water in water reservoir 20 reaches the predetermined set temperature.

On verification that the temperature of the water in water reservoir 20 is at least the predetermined set temperature, central control unit 40 initiates the heat recapture mode (step 220) wherein while continuing to operate water pump 22, water heater 24 is deactivated, thus delivering any residual heated water back to water reservoir 20. Central control unit 40 maintains heating system 10 in heat recapture mode for a sufficient period of time to transfer substantially all of the heat-laden water back to water reservoir 20.

At step 225, central control unit 40 monitors for user input. Where user input is not detected, the system returns to stand-by mode and further monitors the temperature of water contained in water reservoir 20. Where user input is detected, the system determines (step 230) the nature of the user input. If hot water is being requested, central control unit 40 instructs for recirculation mode (step 235), activates water heater 24 and water pump 22, thereby permitting a user to remove heated water at spigot 34 located on conduit 31. If a brewed beverage is being requested, central control unit 40 instructs for dispensing mode (step 240), activates water heater 24 and water pump 22, thereby directing heated water to demand point 28 (e.g. beverage brewing apparatus). On completion of hot water delivery to spigot 34 (step 245), or on completion of brew cycle at demand point 28 (step 250), heating system 10 again switches to heat recapture mode (step 255), wherein while continuing to operate water pump 22, water heater 24 is deactivated, and water directing device 26 is directed for water flow through conduit 31, back to water reservoir 20. Central control unit 40 maintains heating system 10 in heat recapture mode for a sufficient period of time to transfer substantially all of the heat-laden water back to water reservoir 20, after which it returns (step 260) heating system 10 back to stand-by mode.

In the beverage brewing process, particularly in respect of brewing coffee using prepackaged beverage cartridges, there are three primary variables that define the quality and character of the brewing process. In general, these variables are pressure, time and temperature. For beverage dispensing machines that use beverage cartridges, operational pressures are generally at least 1 bar (˜15 psi) to ensure adequate passage of water through the beverage extract provided in the cartridge. With respect to time, optimal time for beverage dispensing is dependent upon the extraction of flavour from the extract. Where the time allowed for extraction is too short, a weak/dilute product may result. Where the time allowed for extraction is too long, an excessively strong and bitter product may result. As such, the time allotted to deliver the requested volume is selected to achieve the proper contact time of the water with the beverage extract. With respect to temperature, as previously mentioned for brewing coffee, the optimal brewing temperature is generally in the range of 195° F. to 205° F.

It was been noted that water pumps used in hot beverage dispensing systems generally operate at reduced efficiency at the above-noted optimal brewing temperatures. It has also been noted that the optimal brewing temperatures result in a reduced life expectancy of the water pump. In water heater 10, water pump 22 is advantageously positioned between water reservoir 20 and water heater 24, thereby subjecting water pump 22 to lower operational temperatures, generally in the range of 130° F. As such, for water pumps that exhibit decreased operational efficiency at elevated temperatures, the lower operational temperature provides enhanced operational benefits, and permits for a wider range of water pumps to be used in the hot beverage dispensing system.

In general, water heater 10 provides a range of environmental, economic and operational benefits. By maintaining the bulk volume of water in water reservoir 20 at a lower temperature, the overall energy input into the system is decreased, particularly during periods where the system is readied, but not regularly being used. The overall energy input is further reduced through the incorporation of the heat recapture modality, as well as by improving the operational efficiency of water pump 22. As such, the system provides for both environmental benefits in the form of reduced energy demand, as well as economic benefit in the form of reduced overall operational cost. In addition, the improved operational efficiency and increased life expectancy of system components (e.g. water pump 22) due to operation of the system at lower temperatures leads to operational benefits, such as decreased down time due to system malfunction, maintenance and repair.

To further improve the efficiency and environmental benefits of heating system 10, water reservoir 20, as well as other system components and associated plumbing may be provided with suitable insulation to decrease the loss of heat.

While central control unit 40 monitors and governs the operation of the heating system 10 based on set parameters, for example the processes defined in FIGS. 3 and 4, the central control unit can be configured with a manual override to force heating system into the dispensing mode. For example, central control unit 40 can be enabled to override the recirculation mode and switch to the dispensing mode upon a suitable input, such as pressing the dispense button for >3 seconds.

While certain temperatures have been specified above, namely with respect to the predetermined temperatures for water reservoir 20 and the optimal brew temperature, these values are intend to be merely exemplary. It will be appreciated that other values may be used, for example the predetermined temperature for water reservoir 20 may be selected from any temperature between 130° to 140° C., as well as other values lower or higher than this range. Similarly, while the optimal brew temperature has been identified as 195° C. to 205° C., other suitable brew temperatures may be implemented. In some embodiments, central control unit 40 may be configured to permit adjustment of these various temperatures that govern the operation of the system. For example, the brewing temperature may be adjusted based on certain factors, such as the degree of extraction desired, or geographical location (e.g. positioning of water heater relative to sea level).

It will be appreciated that, although embodiments have been described and illustrated in detail, various modifications and changes may be made. While several embodiments are described above, some of the features described above can be modified, replaced or even omitted. Further alternatives and modifications may occur to those skilled in the art. All such alternatives and modifications are believed to be within the scope of the invention and are covered by the claims appended hereto.

1. A water heating system for use in a hot beverage dispensing machine, comprising:
a water reservoir enabled to store a volume of water suitable for use in said hot beverage dispenser;
a water pump enabled to receive water from said water reservoir and pump said water through said system;
a water heater enabled to receive water from said water pump, said water heater being configured to heat water passing therethrough;
a water directing device enabled to receive water from said water heater, said water directing device being capable of selecting between a recirculation mode, and a dispensing mode;
wherein during said recirculation mode, said water heater is activated, and said water directing device directs water back to said water reservoir, so as to heat and maintain said water in said water reservoir at a predetermined set temperature intermediate that of room temperature and a predetermined brew temperature; and
wherein during said dispensing mode, said water heater is activated, and said water directing device delivers said water to a demand point, said water heater serving to boost the temperature of said water to said predetermined brew temperature.

2. A water heating system according to claim 1, wherein said predetermined temperature of said water reservoir is in the range of about 130° C. to about 140° C.

3. A water heating system according to claim 1, wherein said predetermined brew temperature is in the range of about 195° C. to about 205° C.

4. A water heating system according to claim 1, further comprising a spigot for dispensing hot water from said system.

5. A water heating system according to claim 1, wherein said water reservoir is configured for manual filling.

6. A water heating system according to claim 1, wherein said water reservoir is configured to be directly connected to a water source.

7. A water heating system according to claim 1, further comprising a central control unit for controlling at least one or more of said water pump, said water heater and said water directing device.

8. A water heating system according to claim 7, further comprising at least one sensor, wherein each sensor is operably connected to said central control unit.

9. A water heating system according to claim 8, wherein two sensors are provided, a first sensor for measuring water temperature in said water reservoir, and a second sensor for measuring water level in said water reservoir.

10. A water heating system according to claim 7, wherein said central control unit is provided with a user interface.

11. A water heating system according to claim 9, wherein said recirculation mode is engaged and maintained so long as said first sensor is detecting a water temperature in said water reservoir that is below said predetermined temperature.

12. A water heating system according to claim 7, further comprising a temperature sensor positioned subsequent to said water heater for measuring the temperature of water exiting said water heater, said central control unit being configured to receive this temperature data and adjust one or both of said water heater and said water pump to alter the quantity of heat transferred to said water.

13. A water heating system according to claim 1, wherein said system is operable in a heat recapture mode during which said water heater is de-activated, and said water directing device directs water back to said water reservoir, so as to transfer residual heater water back to said water reservoir.

14. A water heating system according to claim 1, further comprising an air pump provided between said water directing device and said demand point, said air pump directing a predetermined volume of air through to said demand point following a dispensing mode operation.

15. A method of heating water for a hot beverage dispensing apparatus, said method comprising:
heating a first volume of water to a predetermined temperature intermediate that of room temperature and a predetermined brew temperature and maintaining said first volume of water at said predetermined temperature;
heating a second volume of water removed from said first volume of water to a predetermined brew temperature; and
delivering said second volume of water to a demand point for brewing a hot beverage.

16. A method of heating water according to claim 15, wherein said heating and said maintaining said first volume of water is performed during a recirculation mode, wherein said first volume of water is recirculated through a recirculation loop comprising a water heater.

17. A method of heating water according to claim 16, wherein said heating and said delivering of a second volume of water is performed during a dispensing mode, wherein said second volume of water is directed through said water heater, and subsequently to a demand point.

18. A method of heating water according to claim 15, further comprising directing residual heated water back to said first volume of water following completion of a dispensing mode cycle.

19. A method of heating water according to claim 15, further comprising directing a volume of air through to said demand point following completion of said dispensing mode.

20. In a water heating system for use in a hot beverage dispenser, a method of heating water comprising:
preheating a reservoir of water to a predetermined temperature intermediate that of room temperature and a predetermined brew temperature;
increasing the temperature of a select volume of water from said reservoir of water to a predetermined brew temperature immediately prior to delivery to a demand point;
wherein said preheating and said increasing of temperature are each performed by a single water heater provided in said water heating system.
